(19) United States
(12) Patent Application Publication
(10) Pub. No.: US 2021/0001911 A1
(43) Pub. Date: Jan. 7, 2021

(54) POWER RECEIVING DEVICE, POWER SUPPLY DEVICE, AND POWER SUPPLY SYSTEM

(71) Applicant: TOSHIBA TEC KABUSHIKI KAISHA, Tokyo (JP)

(72) Inventors: Takahiro KOGOSHI, Sunto Shizuoka (JP); Kazuyuki MATSUMURA, Numazu Shizuoka (JP)

(21) Appl. No.: 16/876,355

(22) Filed: May 18, 2020

(30) Foreign Application Priority Data
Jul. 2, 2019 (JP) 2019-124054

(51) Int. Cl. B62B 3/14; H02J 50/10; H02J 50/40; H02J 50/90

(52) U.S. Cl. CPC B62B 3/1472; H02J 50/90; H02J 50/40; H02J 50/10

(57) ABSTRACT

A shopping cart and a shopping cart system are provided. A shopping cart includes a cart body having one or more wheels, a non-contact power receiving device, and a cleaning member. The non-contact power receiving device is mounted on a bottom portion of the cart body. The non-contact power receiving device has a power receiving surface region on a bottom surface thereof. The cleaning member is provided at the bottom portion of the cart body. The cleaning member extends downward beyond the bottom surface of the non-contact power receiving device and is provided closer to a front end of the cart body than is the power receiving surface.

This application is based upon and claims the benefit of priority from Japanese Patent Application No. 2019-124054, filed on Jul. 2, 2019, the entire contents of which are incorporated herein by reference.

### FIELD

Embodiments relate to a power receiving device, a power supply device, and a power supply system.

### BACKGROUND

A mobile robot and other moveable electronic devices are known. Such a mobile robot or device may incorporate a battery that can be charged in a non-contact manner.

When the robot or device is on a charging device, an electrode surface facing upward in the charging device and an electrode surface facing downward in the robot are positioned to face each other to enable charging in a non-contact manner across a gap left between the electrode surfaces.

When a foreign object (e.g., dirt or grit) is left on the electrode surface of the charging device, charging efficiency may be reduced.

### BRIEF DESCRIPTION OF THE DRAWINGS

FIG. 1 illustrates a perspective view of a power receiving device according to a first embodiment.

FIG. 2 illustrates a bottom view of a power receiving device according to a first embodiment.

FIG. 3 illustrates a perspective view of a power receiving unit according to a first embodiment.

FIG. 4 illustrates a perspective view of a part of a cleaning member according to a first embodiment.

FIG. 5 illustrates a perspective view of a power supply device according to a first embodiment.

FIG. 6 illustrates a perspective view of stacked shopping carts on a non-contact charging cart station according to a first embodiment.

FIG. 7 is a diagram for illustrating aspects of the movement of a cleaning member according to a first embodiment.

FIG. 8 is a diagram illustrating a docked state of the cleaning member according to the first embodiment.

FIG. 9 is a diagram for illustrating aspects of the movement of a cleaning member according to a second embodiment.

FIG. 10 is a diagram illustrating a docked state of a cleaning member according to a second embodiment.

FIG. 11 is a diagram depicting a modified example of a cleaning member.

### DETAILED DESCRIPTION

In general, according to an embodiment, a shopping cart includes a cart body having one or more wheels, a non-contact power receiving device, and a cleaning member. The non-contact power receiving device is mounted on a bottom portion of the cart body. The non-contact power receiving device has a power receiving surface region on a bottom surface thereof. The cleaning member is provided at the bottom portion of the cart body. The cleaning member extends downward beyond the bottom surface of the non-contact power receiving device and is provided closer to a front end of the cart body than is the power receiving surface.

Hereinafter, certain example embodiments of a power receiving device, a power supply device, and a supply system will be described with reference to the drawings. In the example embodiments, a shopping cart having a product scanner is used as one non-limiting example of a power receiving device configured to receive electric power from a power supply device in a non-contact manner (that is, wirelessly). A non-contact charging cart station for such a shopping cart is used as a non-limiting example of a power supply device. The present disclosure is not limited to these example embodiments.

### First Embodiment

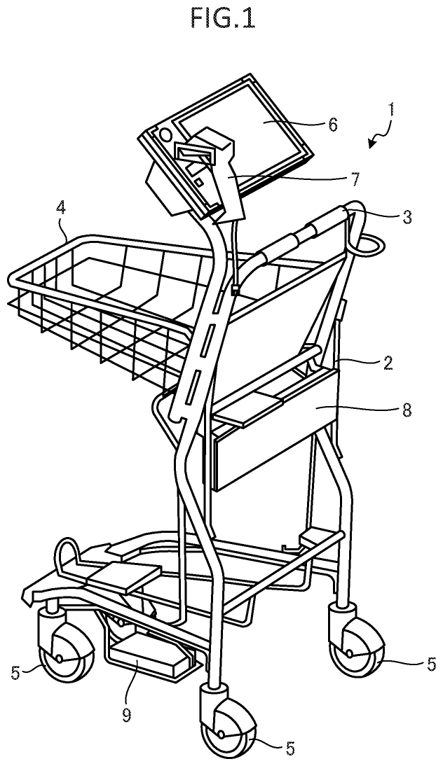

First, a cart 1, which is an example of a power receiving device, will be described. The cart 1 is a handcart used in a store such as a supermarket, and is capable of transporting goods being purchased by a customer. The cart 1 may be referred to as a shopping cart. As shown in FIG. 1, the cart 1 includes a main body 2 including a plurality of frames, a handle portion 3, a housing part 4 either providing a shopping basket or a place on which a shopping basket can be placed, casters 5, a tablet terminal 6, a scanner 7, a battery holder 8, and a power receiving unit 9. The main body 2 is supported by the casters 5 so as to be movable in the horizontal direction. The casters 5 support the main body 2 and permit the main body to move along a floor or the like. The casters 5 may also be referred to as wheels.

The handle portion 3 is formed of a portion of the frame of the main body 2 and permits the customer to push or otherwise move the cart 1. The housing part 4 is adjacent to the handle portion 3, and, in this example, forms a basket for storing the commodities being purchased by the customer. The casters 5 are rotatably attached to each of the four legs of the cart 1. The distance between the pair of casters 5 close to the handle portion 3, e.g., rear wheels, is wider than the one between the other pair of casters 5, e.g., front wheels. In the embodiment, the side on which a pair of casters 5 having a narrower distance are provided is defined as a front side, and the side on which the pair of casters 5 having a wider distance are provided is defined as a rear side.

The tablet terminal 6 is detachably provided on the main body 2. The scanner 7 is detachably provided on the main body 2 an includes a power cord. The scanner 7 is used by the customer to a bar code or the like attached to each commodity to be purchased. The tablet terminal 6 registers product information based on the barcode(s) read by the scanner 7. Later, an accounting or settlement apparatus performs transaction accounting/settlement processing based on the product information transmitted from the tablet terminal 6. In this context, accounting/settlement processing comprises the processing for displaying a total amount of money due based on the transmitted product information, calculating and displaying the change due based on a cash payment deposited by the customer, and the issuing and/or printing of a receipt including the sales transaction details such as list of products/items purchased, the settlement information (total amount due, deposited amount, change due amount, etc.). The battery holder 8 holds a battery for supplying power to the scanner 7.

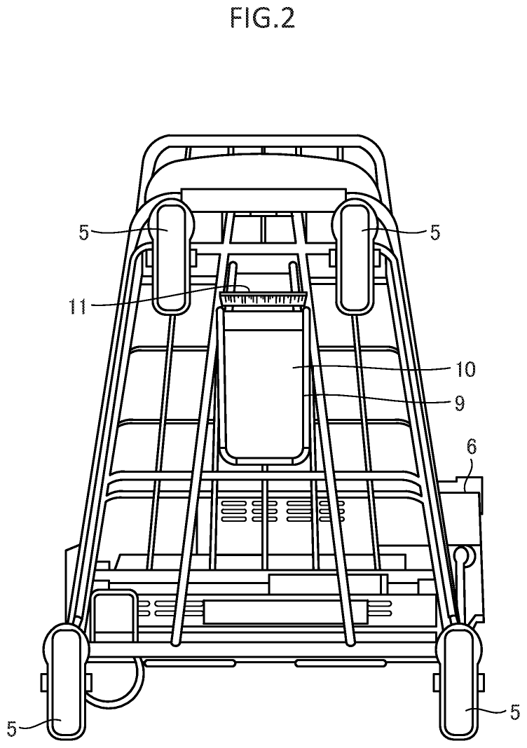

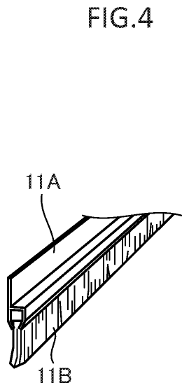

Next, the power receiving unit 9 will be described with reference to FIG. 2 to FIG. 4. The power receiving unit 9 is provided on the main body 2 and is supplied with electric power from a power supply unit which will be described below. The power receiving unit 9 includes a planar power receiving surface 10 facing downward, a cleaning member 11, a power receiving circuit including a power receiving coil, and a charging circuit. The power receiving surface 10 is an electrode surface and is disposed between the casters 5 on the front side and the casters 5 on the rear side. The power receiving coil is disposed along the power receiving surface 10. The power receiving circuit receives electric power from the power supply unit. The charging circuit converts the received power into a DC voltage to charge the battery.

The cleaning member 11 protrudes downward from the power receiving surface 10.

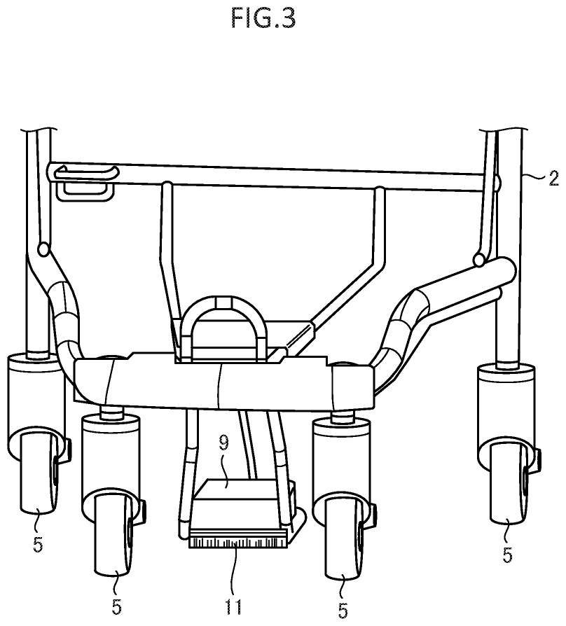

As shown in FIGS. 2 and 3, the cleaning member 11 is disposed on the front side of the power receiving surface 10, and is provided along the front edge or the front surface of the power receiving surface 10.

That is, the cleaning member 11 is disposed on the front side of the power receiving surface 10 in a direction (hereinafter referred to as the “moving direction”) in which the cart 1 is moved when it is being stored in a non-contact charging cart station.

It is preferable that the width of the cleaning member 11 in the left-right direction (the direction perpendicular to the moving direction, which may be referred to as a lateral direction) is wider than the width in the left-right direction of the power receiving surface 10.

The cleaning member 11 includes a mounting part 11A which can be detachably attached to a holding portion of the power receiving unit 9, and a brush 11B which is provided on the mounting part 11A.

The brush 11B is made of, for example, elastic bristles or fibers, and its lower end projects downward from the power receiving surface 10.

In some examples, the cleaning member 11 may be or include a thin plate-like rubber blade or the like instead of or in addition to bristles, and may be angled in the front-rear direction.

The cleaning member 11 is attachable and detachable to and from the power receiving unit 9 so as to be replaceable when the function of the brush 11B has been reduced due to deformation of the brush 11B over time or the like.

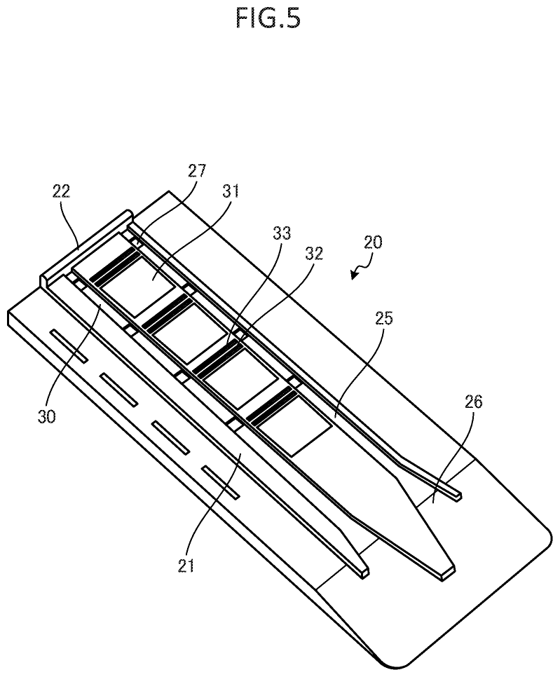

Next, a non-contact charging cart station 20, which is a power supply device, will be described with reference to FIG. 5. The non-contact charging cart station 20 is provided in a cart place in a store of a supermarket. The non-contact charging cart station accommodates a plurality of carts which are not presently being used by customers. The non-contact charging cart station 20 includes a guide 21, a stopper 22, and a plurality of (four in the first embodiment) power supply units 30.

The guide 21 guides the pair of front casters 5 of s cart 1, and includes guide grooves 25 integrally formed along a longitudinal direction (hereinafter referred to as “front-rear direction” or “cart placement direction) of the non-contact charging cart station 20. The guide groove 25 has a wide guide portion 26 in the rear side in the front-rear direction. The guide groove 25 includes a positioning portion 27. The positioning part 27 is constituted by a recessed part formed on the bottom surface of the guide groove 25, and when the front casters 5 of the cart 1 are inserted, the cart 1 is positioned at a position corresponding to a power supply unit 30. The positioning portion 27 is provided in the same number as the power supply units 30 at a predetermined interval in the front-rear direction of the guide groove 25.

The stopper 22 is positioned at the front end in the front-rear direction of the non-contact charging cart station 20 so as to project upward. The width in the left-right direction of the stopper 22 is wider than the width of the guide 21. The stopper 22 has a function of preventing the cart 1 guided by the guide 21 from jumping forward out from the non-contact charging cart station 20.

The power supply unit 30 is positioned between a pair of guide grooves 25, and is provided in a plurality of positions along the front-rear direction of the non-contact charging cart station 20. The power supply unit 30 includes a power supply surface 31, which is an electrode surface, on a plane facing upward, and a power supply circuit including a power supply coil (not shown). The power supply unit 30 is provided corresponding to the positioning portion 27. When the cart 1 is positioned at a predetermined position with the positioning portion 27, the power supply surface 31 is opposed to the power receiving surface 10 of the cart 1 with a distance of about one centimeter. In this state, electricity is supplied to the power supply coil to generate electromagnetic induction, so that the power supply unit 30 supplies power to the power receiving unit 9 in a non-contact manner. As a method of non-contact power supply, various methods such as electromagnetic induction type and magnetic field resonance type are known, but various types of methods can be used. In the present embodiment, the term “non-contact” refers to a state in which the power transmission is carried out wirelessly. Therefore, even if the power supply surface 31 and the power receiving surface 10 are in contact with each other at the time of power supply, regardless of whether this contact is intended or not, the power transmission can still be considered to be performed in a non-contact manner so long as the power transmission is performed wirelessly.

The power supply unit 30 includes a foreign matter housing groove 32 located on the front side of the power supply surface 31 and a brush housing groove 33 positioned on the front side of the foreign matter housing groove 32. Each of the foreign matter housing grooves 32 and the brush housing grooves 33 has a width in the left-right direction equal to or slightly larger than the width in the left-right direction of the power supply surface 31. The depth of the brush housing groove 33 is shallower than the depth of the foreign matter housing groove 32.

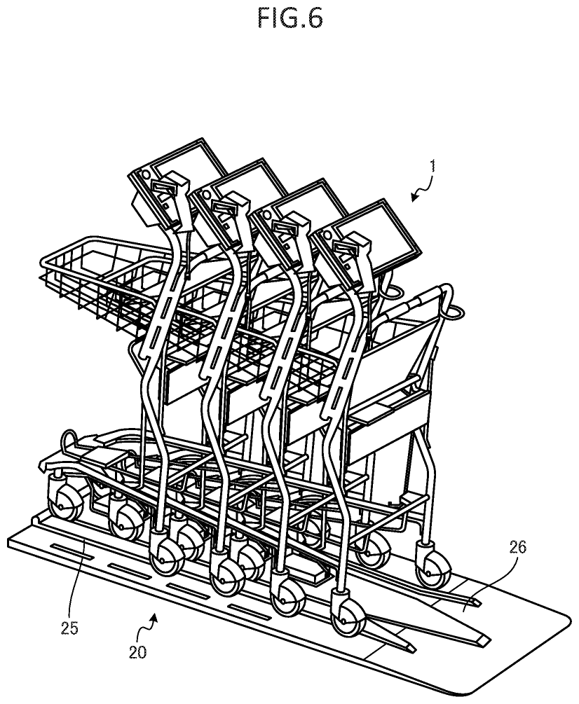

FIG. 6 shows a state in which four carts 1 have been stacked and placed on the non-contact charging cart station 20. As is well known, each cart 1 can be arranged such that a portion thereof is overlapped in the front-rear direction with one or more carts 1 in the stack. In FIG. 6, the power receiving surfaces 10 of the carts 1 are opposed to each other in the vertical direction on respective power supply surfaces 31 of the non-contact charging cart station 20. In this example, the power receiving surface 10 is an upper surface, and the power supply surface 31 is a lower surface. When the cart 1 is placed on the non-contact charging cart station 20, the power receiving unit 9 charges the battery of the cart 1 with electric power received from the power supply unit 30. The power supply system includes one or more carts 1 as power receiving devices and the non-contact charging cart station 20 as a power supply device.

Next, a point at which the cart 1 is placed on the non-contact charging cart station 20 and power is received from the power supply unit 30 will be described. When the customer finishes shopping, a customer or a supermarket employee (hereinafter referred to as “customer, etc.”) moves the front casters 5 of the cart 1 into the guide groove 25 through the guide portion 26 of the non-contact charging cart station 20. When there are no carts 1 on the non-contact charging cart station 20, the cart 1 that is introduced onto the non-contact charging cart station 20 is positioned at a position corresponding to the foremost power supply surfaces 31 located on the non-contact charging cart station 20.

The customer, etc. pushes the cart 1 to move the front casters 5 forward in the guide groove 25. At this time, although the front casters 5 enter the first positioning portion 27 on the guide portion 26, the customer, etc. can push the cart 1 forward so as to exceed the first positioning portion 27. Then, after passing through the first three positioning portions 27, the front casters 5 enter the positioning portion 27 positioned at the foremost side. Even if the customer, etc. erroneously pushes the cart 1 forward, the cart 1 is prevented from being moved farther by its front end portion contacting the stopper 22. As described above, when the cart 1 is positioned at a predetermined position, the power receiving surface 10 of the power receiving unit 9 and the power supply surface 31 of the power supply unit 30 are opposed to each other in the vertical direction, so that power is supplied to the power supply unit 27.

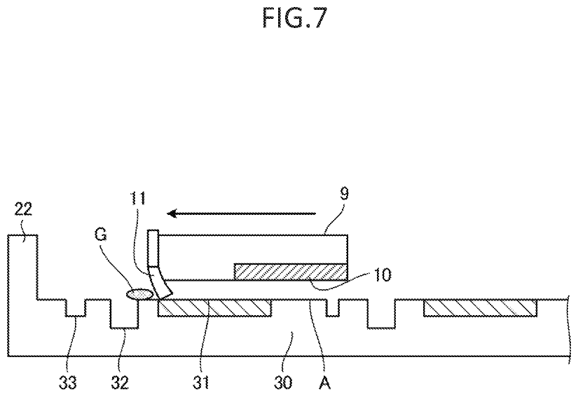

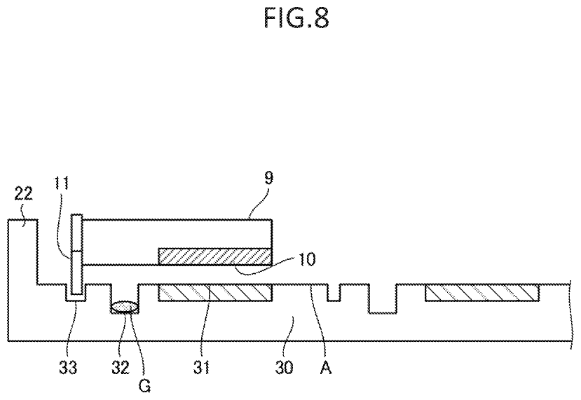

The function of the cleaning member 11 in the process of placing the cart 1 at a predetermined position on the non-contact charging cart station 20 will now be described with reference to FIGS. 7 and 8. When a customer, etc. takes the cart 1 into and out of the non-contact charging cart station 20, foreign matter such as dust or grit may fall on the supply surface of the non-contact charging cart station 20. In FIG. 7, foreign matter such as dust is represented with the reference symbol “G”.

When the cart 1 is moved along the guide 21 after the front casters 5 of the cart 1 are positioned in the guide portion 26, the lower end of a cleaning member 11 provided on the front side of the power receiving surface 10 is brought into contact with the upper surface A of the power supply unit 30 and is slightly bent. When a customer, etc. pushes the cart 1 in this state, as shown in FIG. 7, the cart 1 moves, and the cleaning member 11 moves while rubbing against the upper surface A of the power supply unit 30 and then power supply surface 31 which is flush with the upper surface A. At this time, the cleaning member 11 cleans the upper surface A and the power supply surface 31 and removes the foreign matter G.

That is, the cleaning member 11 sweeps the foreign matter G from the power supply surface 31 into the foreign matter housing groove 32. The cart 1 is then further moved and positioned in a predetermined position (see FIG. 8). In this position, which may be referred to as a docked state, the power receiving surface 10 and the power supply surface 31 are opposed to each other in the vertical direction. The distal end of the cleaning member 11 is positioned within the brush housing groove 33, and the cleaning member 11 returns from the flexed state to the natural state.

In the present embodiment, the power receiving surface 10 and the power supply surface 31 are opposed to each other in the vertical direction in a configuration in which the power receiving device is moved in the horizontal direction and the power receiving surface and the power supply surface face are opposed to each other, so that the following advantages are obtained as compared with the case where they are opposed to each other in a horizontal direction. In order to supply power to the power receiving unit 9 from the power supply unit 30, it is necessary for the power receiving surface 10 and the power supply surface 31 to face each other in an appropriate state. A suitable condition is a predetermined relationship in which both the distance between the power receiving surface 10 and the power supply surface 31 in the direction opposite to each other and the position of the power receiving surface 10 and the power supply surface 31 in the direction along the surface are made to be able to be supplied with electric power.

In the case where the casters 5 of the cart 1 contact a floor surface and the cart 1 moves in a state where the distance to the floor surface is constant, the distance between the power receiving surface 10 and the power supply surface 31 is kept constant by having the both oppose each other in the vertical direction. An advantage to having surfaces opposed to each other in the vertical direction is that additional structural elements that might be required for positioning surfaces opposed to each other in the horizontal direction can be avoided.

According to the present embodiment, when the cart 1 is moved so that the power receiving surface 10 and the power supply surface 31 are opposed to each other, the cleaning member 11 provided on the front side (front side in the moving direction of the cart 1) of the power receiving surface 10 and projecting downward sweeps the upper surface of the power supply surface 31 while abutting the power supply surface 31.

Thus, any foreign matter on the upper surface of the power supply surface 31 can be removed by the sweeping action of the cleaning member 11 prior to charging, so the decrease in power supply efficiency from the power supply unit 30 to the power receiving unit 9 that might result from the continued presence of foreign matter can be avoided.

More specifically, in a case in which power supply is performed and the foreign matter is as a metal, if such metallic foreign matter is placed on the power supply surface 31 and is left between the power receiving surface 10 and the power supply surface 31, then foreign matter is subjected to the magnetic flux energy from the power supply unit 30 which may generate heat, which causes unnecessary power loss, but according to the present embodiment, such decrease of power supply efficiency can be reduced or avoided.

Moreover, since the foreign matter on the power supply surface 31 can be removed during the housing operation of each cart 1, it is not necessary to perform any special operation for removing the foreign matter, so that it is possible to more easily avoid the deterioration of the power supply efficiency.

Further, according to the present embodiment, since the foreign matter housing groove 32 for housing the foreign matter is provided, the removed foreign matter is less likely to be scattered about the cart storage location. Therefore, it is generally only necessary to clean the foreign matter housing groove 32, and it is not necessary to carry out more troublesome cleaning of the entire cart storage location. Further, if a detachable cartridge is attached to the foreign matter housing groove 32, disposal of foreign matters can be made easier by removal of the detachable cartridge for cleaning.

In addition, according to the present embodiment, since the brush housing groove 33 for receiving the tip of the brush 11B is provided in a state where the cart 1 is positioned at a predetermined position where the power receiving surface 10 and the power supply surface 31 are opposed to each other, it is possible to suppress deterioration in durability of the cleaning member 11. That is, since the brush 11B has a function of removing foreign matter by sweeping the power supply surface 31, when it is on the power supply unit 30, it is in a bent state, but when the brush 11B is kept in a bent state for a prolonged time, then the bristles may not return to previous unbent, natural state. Accordingly, deformation of the brush 11B can be suppressed by providing the brush housing groove 33, and as a result, deterioration of the cleaning member 11 can be suppressed.

### Second Embodiment

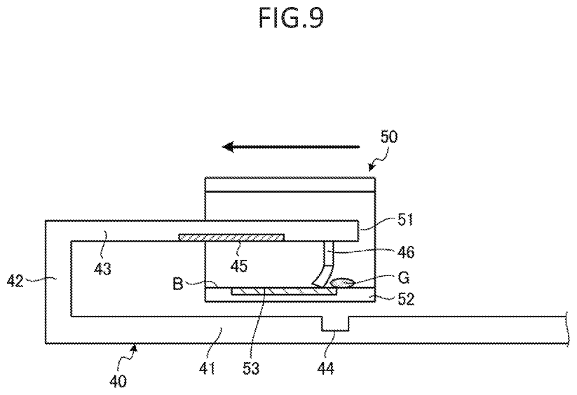

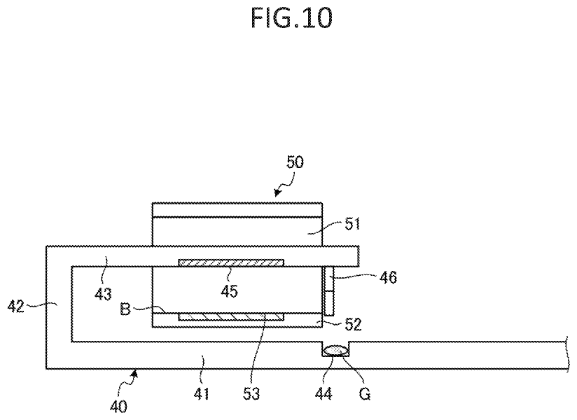

Next, a second embodiment will be described with reference to FIG. 9 and FIG. 10. FIGS. 9 and 10 show a part of a cart 50 and a part of a non-contact charging cart station 40. The second embodiment differs from the first embodiment in the following aspects. The number of power supply device unit provided on the non-contact charging cart station is one. The power supply surface constitutes an upper surface and faces downward. The power receiving surface constitutes a lower surface and faces upward. The cleaning member is provided on the non-contact charging cart station side to sweep the power receiving surface.

The non-contact charging cart station 40 serves as a power supply device for supplying power to the cart 50 in a non-contact manner, and includes a bottom portion 41, a support arm portion 42 and a power supply unit 43. The bottom portion 41 includes a foreign matter housing groove 44. The support arm portion 42 extends upward from the bottom portion 41 and supports the power supply unit 43 spaced above from the bottom portion 41. The power supply unit 43 overhangs above the bottom portion 41 and includes a power supply surface 45 facing downward and a cleaning member 46 disposed behind the power supply surface 45 in the cart placement direction. Here, the side from which the cart 50 enters (the right side in FIG. 9) is defined to as the rear side.

The cart 50 has a support part 51 at a front end portion thereof.

The support part 51 includes a power receiving unit 52 which is parallel to the power supply unit 43.

The power receiving surface 53 in the power receiving unit 52 faces upward so as to face the power supply surface 45 in the vertical direction.

With reference to FIGS. 9 and 10, the movement of the cleaning member 46 when the cart 50 is being placed in a predetermined position in the non-contact charging cart station 40 will be described. When there are many customers, foreign matter G, such as dust or grit may accumulate on the power receiving surface 53 during shopping. The cleaning member 46 removes the foreign matter G from the power receiving surface 53 during the housing of the cart 50 at the non-contact charging cart station 40.

As described in conjunction with FIGS. 7 and 8, when the cart 50 is moved in the direction of the arrow, the lower end of the cleaning member 46 is brought into contact with the upper surface B of the power receiving unit 52 and is slightly bent. When the cart 50 further moves from this state, the cleaning member 46 comes into contact with the upper surface B of the power receiving unit 52 and the receiving surface 53, which is flush with the power receiving unit 52. At this time, the cleaning member 46 cleans the upper surface B and the power receiving surface 53 to remove foreign matter therefrom.

Thereafter, the cart 50 is further moved, and when the power receiving surface 53 and the power supply surface 45 are in a predetermined position and opposed to each other in the vertical direction, the cart 50 is appropriately positioned on the non-contact charging cart station 40. In this state, as shown in FIG. 10, the cleaning member 46 is separated from the upper surface B and returns to its unbent, natural state. At this time, the foreign matter G removed by the cleaning member 46 is housed in the foreign matter housing groove 44.

According to the second embodiment, the cart 50 moves and the cleaning member 46 sweeps the power receiving surface 53. Therefore, the foreign matter on the power receiving surface 53 can be removed before the power supply from the power supply unit 43 to the power receiving unit 52 begins. Therefore, as in the first embodiment described above, it is possible to prevent the power supply from being performed while the foreign matter is still between the power receiving surface 53 and the power supply surface 45, so that it is possible to avoid a reduction in the power supply efficiency.

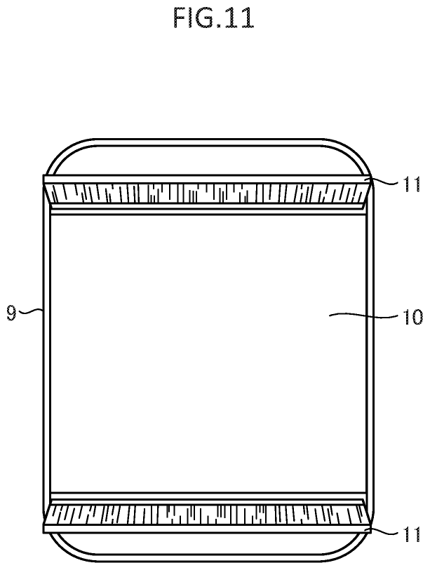

Next, a modified example relating to the cleaning member 11 will be described with reference to FIG. 11. FIG. 11 shows a modified example of the power receiving unit 9 according to the first embodiment or the power supply unit 43 according to the second embodiment. Here, a modification example of the power receiving unit 9 according to the first embodiment will be representatively described. A modification of the power supply unit 43 may be made in the same manner.

The difference from the first embodiment is that the cleaning member 11 is disposed on the front side and the rear side in the moving direction of the cart 1 with a power receiving surface 10 therebetween. The moving direction of the cart 1 is the direction in which the cart 1 moves along the guide 21.

According to the above structure, when the cart 1 is moved to a predetermined position where the power receiving surface 10 and the power supply surface 31 face each other, even if the cart 1 is erroneously moved to a position beyond a predetermined position, and it is left in this state for a fixed time, the foreign matter on the power supply surface 31 can be removed before supply of electric power. This is because when the cart 1 is returned to the predetermined position from a position beyond the predetermined position, the cleaning member 11 disposed on the rear side of the power receiving surface 10 can sweep the power supply surface 31. When the cleaning member 46 in the second embodiment is disposed on the front side and the rear side in the moving direction of the cart 1 with the power supply surface 45 therebetween, the same effect can be obtained that foreign matter on the power receiving surface 53 can be removed before supply of electric power.

For example, in the above-described embodiments, a cart with a point-of-sale (POS) type system is described as an example of a power receiving device, but in other embodiments the power receiving device may be a self-propelled robot equipped with a battery, for example.

In the above-described embodiments, the casters are used as the structure for movably supporting the power receiving device on the surface to be mounted such as a floor, but any applicable mechanism that enables movement in a horizontal direction can be employed.

In addition, although a brush having a length sufficient for contact with the power receiving surface and the power receiving surface opposite to each other is adopted as a cleaning member, such a brush does not necessarily have to come into contact with the power supply surface or the power receiving surface. The cleaning member is not required to contact the surface to be cleaned and need not necessarily be comprised of flexible bristles or the like. In general, any clean member type that can remove foreign matter from the surface to be cleaned can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A shopping cart, comprising:
a cart body having one or more wheels;
a non-contact power receiving device mounted on a bottom portion of the cart body, the non-contact power receiving device having a power receiving surface region on a bottom surface thereof; and
a cleaning member at the bottom portion of the cart body, the cleaning member extending downward beyond the bottom surface of the non-contact power receiving device and nearer a front end of the cart body than is the power receiving surface region.

2. The shopping cart according to claim 1, wherein the cleaning member extends downward beyond the one or more wheels.

3. The shopping cart according to claim 1, wherein the cleaning member is attached to the non-contact power receiving device.

4. The shopping cart according to claim 1, wherein a width of the cleaning member in a lateral direction of the cart body is equal to or greater than a width of the non-contact power receiving device in the lateral direction.

5. The shopping cart according to claim 4, wherein
the one or more wheels include two front wheels that are aligned in the lateral direction, and
the width of the cleaning member in the lateral direction is less than a distance between the two front wheels.

6. The shopping cart according to claim 1, wherein
the one or more wheels include a front wheel, and,
the cleaning member is closer to a rear end of the cart body than is a rotational axis of the front wheel.

7. The shopping cart according to claim 1, wherein the cleaning member is closer to the front end of the cart body than is a front end of the non-contact power receiving device.

8. The shopping cart according to claim 1, wherein the cleaning member includes a brush.

9. The shopping cart according to claim 1, further comprising:
a second cleaning member at the bottom portion of the cart body, the second cleaning member extending downward beyond the bottom surface of the non-contact power receiving device and closer to a rear end of the cart body than is the power receiving surface.

10. The shopping cart according to claim 9, wherein the second cleaning member extends downward beyond the one or more wheels.

11. A shopping cart system, comprising:
a plurality of shopping carts that are stackable, each of the shopping carts including:
a cart body having one or more wheels;
a non-contact power receiving device mounted on a bottom portion of the cart body, the non-contact power receiving device having a power receiving surface region on a bottom surface thereof; and
a cleaning member at the bottom portion of the cart body, the cleaning member extending downward beyond the bottom surface of the non-contact power receiving device and nearer a front end of the cart body than is the power receiving surface region; and
a non-contact charging cart station including:
a housing having a cart placement surface on which shopping carts are stacked in a cart placement direction; and
a plurality of non-contact power supplying devices that are provided in the housing and aligned along the cart placement surface in the cart placement direction.

12. The shopping cart system according to claim 11, wherein the cart placement surface includes a plurality of grooves forward of the plurality of non-contact power supplying devices in the cart placement direction, respectively, each of the grooves extending in a lateral direction of the housing.

13. The shopping cart system according to claim 12, wherein
the cart placement surface includes a plurality of second grooves forward of the plurality of grooves in the cart placement direction, respectively, and
each of the second grooves is positioned such that at least a part of the cleaning member of one of the shopping carts is located therein when the power receiving surface region of said one of the shopping carts faces a power supplying surface of a corresponding one of the non-contact power supplying devices.

14. The shopping cart system according to claim 13, wherein a depth of the plurality of second grooves is less than a depth of the plurality of grooves.

15. The shopping cart system according to claim 11, wherein the non-contact power receiving device of each of the shopping carts when stacked is located above one of the non-contact power supplying devices.

16. A shopping cart system, comprising:
a plurality of shopping carts that are stackable, each of the shopping carts including:
a cart body having one or more wheels; and
a non-contact power receiving device mounted on the cart body, the non-contact power receiving device having a power receiving surface region facing upward; and
a non-contact charging cart station including:
a housing having a cart placement surface on which the shopping carts can be stacked in a cart placement direction;
a non-contact power supplying device in the housing and aligned along the cart placement surface, the non-contact power supplying device having a power supplying surface region facing downward; and
a cleaning member extending downward beyond the power supplying surface region.

17. The shopping cart system according to claim 16, wherein the cleaning member contacts the power receiving surface region of the shopping carts when the shopping carts are on the cart placement surface.

18. The shopping cart system according to claim 17, wherein when the power receiving surface region of one of the shopping carts faces the power supplying surface region, the cleaning member is not in contact with the power receiving surface region of the one of the shopping carts.

19. The shopping cart system according to claim 17, wherein the housing of the non-contact charging cart station includes a bottom portion having the cart placement surface and an overhanging portion in which the non-contact power supplying device is provided and from which the cleaning member extends.

20. The shopping cart system according to claim 19, wherein the cart placement surface includes a groove in a region of the bottom portion.
